(19) United States
(12) Patent Application Publication
(10) Pub. No.: US 2026/0322611 A1
(43) Pub. Date: Oct. 15, 2026

(54) SYSTEM AND METHOD FOR INTERACTIVE TRANSACTION FRAMEWORKS INVOLVING EXTERNAL ARTIFICIAL-INTELLIGENCE SERVICES WITHOUT REVEALING USER IDENTITY

(71) Applicant: Amod Ashok Dange, Mountain View, CA (US)

(72) Inventor: Amod Ashok Dange, Mountain View, CA (US)

(21) Appl. No.: 19/719,361

(22) Filed: Jun. 25, 2026

Related U.S. Application Data
(63) Continuation-in-part of application No. 19/050,175, filed on Feb. 11, 2025.
Application No. 19/050,175 is a continuation-in-part of application No. 18/782,801, filed on Jul. 24, 2024, now Pat. No. 12,603,780.
Application No. 18/782,801 is a continuation-in-part of application No. 17/481,468, filed on Sep. 22, 2021, now Pat. No. 12,072,963.
Application No. 17/481,468 is a continuation-in-part of application No. 17/018,273, filed on Sep. 11, 2020, now Pat. No. 11,582,032.
(60) Provisional application No. 62/906,080, filed on Sep. 25, 2019.
(60) Provisional application No. 62/954,591, filed on Dec. 29, 2019.
(60) Provisional application No. 63/029,717, filed on May 26, 2020.

(51) Int. Cl. H04L 9/32

(52) U.S. Cl. CPC H04L 9/3221; H04L 9/3231

(57) ABSTRACT

A system and method enable a user to interact with external artificial-intelligence services without revealing user identity or personal data. On a user device, a Secret-Key (S1) derived from a biometric is bound to a secure enclave as non-exportable. By application of a Function (F1), tokenized identity proofs bound to an action category and epoch are derived, each verifiable as originating from a registered verified human without revealing identity. Agentic requests are classified on-device and, when external execution is required, scrubbed of personal content and transmitted through a split-trust transport in which no single party observes both identity and request content. Composition and personalization occur on-device against an encrypted preference datastore that is never transmitted. Actions are metered via rate-limiting nullifiers, premium capability is gated by blind-signed entitlement tokens, and anonymized contributions to an aggregated knowledge graph are threshold-gated and secret-shared across non-colluding aggregators.

### CROSS-REFERENCE TO RELATED APPLICATIONS AND PRIORITY

The present application is a Continuation in Part (CIP) application of U.S. Nonprovisional application Ser. No. 19/050,175, filed on Feb. 11, 2025 entitled “System and method for creating and managing interactive transaction frameworks”, which claims the benefit of and is a CIP of the U.S. Nonprovisional application Ser. No. 18/782,801, filed on Jul. 24, 2024 entitled “System and method for managing an operating system using tokenized identity”, which claims the benefit of and is a CIP of U.S. Nonprovisional application Ser. No. 17/481,468, filed on Sep. 22, 2021 entitled “System and method for affixing a signature using biometric authentication”, which claims the benefit of and is a CIP of U.S. Nonprovisional application Ser. No. 17/018,273 filed on Sep. 11, 2020 entitled “System and method for sharing user preferences without having the user reveal their identity”, which claims the benefit of U.S. Provisional Application No. 63/029,717 filed on May 26, 2020 entitled “Method and system of storing identity and signature using the human body as a node”, the U.S. Provisional Application No. 62/954,591 filed on Dec. 29, 2019 entitled “Method and system for anonymously matching consumers and businesses”, and also the U.S. Provisional Application No. 62/906,080 filed on Sep. 25, 2019 entitled “Method and system of managing personal and business information.”

### TECHNICAL FIELD

The present invention relates to personal-agent software, information retrieval, and agentic artificial intelligence; and more particularly to privacy-preserving personal agents in which user identity, request content, on-device personalization, capability metering, and collective behavioral intelligence are enforced as cryptographic and architectural properties rather than matters of policy. The invention is applicable to consumer personal assistants, in-application agents, agentic retrieval and composition performed on a user's behalf, brokered interactions with any external artificial-intelligence model or service, agent-to-agent privacy mediation, and privacy-regulated markets.

### BACKGROUND

Since the emergence of personal digital assistants and, more recently, artificial-intelligence-powered agents, users have increasingly relied on external services to perform tasks on their behalf. These tasks range from information retrieval and document composition to financial transactions, calendar coordination, and multi-step planning. In every case, the user submits a request, expressed as a natural-language prompt, a structured query, or a tool-call instruction, to a remote service that processes the request and returns a result.

Conventional personal assistants and modern artificial-intelligence agents, including chatbots, retrieval engines, and tool-using agents from providers such as Apple, Google, Amazon, OpenAI, Anthropic, and others, operate by accumulating user prompts, tool-call histories, and interaction logs on centralized servers, thereby constructing detailed behavioral profiles over time. This accumulation creates persistent privacy risk. A single breach exposes not only individual queries but entire interaction histories from which personal beliefs, medical concerns, financial status, and political leanings may be inferred. Additionally, regulatory frameworks including the European Union's General Data Protection Regulation (GDPR), the California Consumer Privacy Act (CCPA), and the Indian Digital Personal Data Protection Act (DPDP) impose significant obligations on operators that collect and retain such data. These obligations include data minimization, purpose limitation, and the right of erasure, which are requirements that are difficult to satisfy when the fundamental architecture of the service depends on retaining comprehensive interaction histories.

So-called private retrieval services attempt to reduce that exposure by proxying queries through a single operator. However, the operator still observes every request in full, and the protection is a matter of organizational policy rather than architectural enforcement. A change in management, a court order, or a data breach at the proxy operator suffices to expose the full history. Moreover, such systems typically forgo personalization, because applying user preferences on the server would require the server to maintain or receive user-specific context, thereby undermining the privacy benefit. These systems also forgo multi-step agentic execution and any collective-intelligence signal derived from aggregate interaction, further limiting their utility.

Trusted-hardware approaches, such as secure enclaves and trusted execution environments, offer the possibility of processing sensitive data without exposing it to the host operator. However, these approaches require trusting hardware-vendor attestations, and they remain vulnerable to side-channel attacks and firmware vulnerabilities that have been demonstrated against several commercial implementations. Furthermore, trusted-hardware solutions alone do not address the problem of how to meter usage, gate premium capabilities, or derive collective behavioral intelligence, each of which requires interaction with external entities beyond the confines of a single enclave.

Differential-privacy and private-aggregation schemes, including RAPPOR, Prio, and STAR, exist in isolation for telemetry data collection. While these schemes provide mathematical privacy guarantees for individual contributions, they have not been integrated with general-purpose agent workflows, and they do not address user authentication, request routing, or personalization. More importantly, existing aggregation schemes do not restrict contributions to verified, deduplicated human users, rendering them vulnerable to bot inflation and Sybil attacks that can distort aggregate signals.

The art does not disclose or suggest the integration of split-trust transport, on-device agent runtime, biometric-bound action metering, blind-signed entitlement, and verified-human-gated collective-intelligence aggregation into a coherent personal-agent platform that supports any agentic action requiring interaction with one or more external services. Prior art further does not disclose deriving aggregate behavioral signals exclusively from verified, deduplicated humans such that the resulting signals are structurally resistant to bot and Sybil inflation. There is accordingly a need in the art for a system and method that structurally separates user identity from request content, personalizes and composes on-device, meters and gates agentic capability anonymously, and derives collective behavioral intelligence from verified humans, all as cryptographic and architectural properties rather than policy commitments.

### SUMMARY

This summary introduces concepts related to a system and method for enabling a user to interact with one or more external artificial-intelligence services without revealing the user identity or personal data. The concepts are further described in the detailed description. This summary is not intended to identify essential features of the claimed subject matter nor to limit its scope.

In one implementation, a method for enabling a user to interact with one or more external artificial-intelligence services such that the services receive an authenticated request without receiving the user identity or personal data is disclosed. The method comprises steps of, at a user device having a secure enclave, receiving a set of biometric samples of the user. Further, the method comprises steps of computing a Secret-Key (S1) from the set of biometric samples on the user device and binding the Secret-Key (S1) to the secure enclave such that the Secret-Key (S1) is non-exportable from the secure enclave. Further, the method comprises steps of deriving, by application of a Function (F1) to the Secret-Key (S1), a tokenized identity proof bound to a context comprising at least an action category and an epoch, the tokenized identity proof being verifiable as originating from a registered verified human in a verified-human registry without revealing the user identity. Further, the method comprises steps of receiving, at the user device, an agentic request from the user. Further, the method comprises steps of classifying the agentic request, on the user device, by intent type via an intent and capability classification and selecting a tier from among a local-execution tier, a local-resource-match tier, and an external-service tier. Further, the method comprises steps of, responsive to selection of the external-service tier, forming a scrubbed request from the agentic request by removing personal entities and terms derived from an encrypted preference datastore stored on the user device. Further, the method comprises steps of transmitting the scrubbed request and the tokenized identity proof through a split-trust transport that conveys the scrubbed request to an external service without conveying the user identity or a network address of the user device. Further, the method comprises steps of receiving a response from the external service via the split-trust transport. Further, the method comprises steps of composing, on the user device, an output by ranking and synthesizing the response against the encrypted preference datastore without transmitting the encrypted preference datastore. Further, the method comprises steps of metering, at an action-nullifier set server, the agentic action by verifying and consuming the tokenized identity proof, the action-nullifier set server recording an aggregate count corresponding to the action category and the epoch, the action-nullifier set server being devoid of a mapping between the aggregate count and the user identity.

In another implementation, a system for enabling a user to interact with one or more external artificial-intelligence services such that the services receive an authenticated request without receiving the user identity or personal data is disclosed. The system comprises a user device having a secure enclave. The user device is configured to compute a Secret-Key (S1) from a user biometric and to bind the Secret-Key (S1) to the secure enclave such that the Secret-Key (S1) is non-exportable from the secure enclave. The user device is further configured to derive, by application of a Function (F1) to the Secret-Key (S1), a tokenized identity proof bound to a context comprising at least an action category and an epoch. The user device is further configured to classify an agentic request by intent type, to form a scrubbed request from the agentic request by removing personal entities and terms derived from an encrypted preference datastore, and to compose an output by ranking and synthesizing a response from an external service against the encrypted preference datastore. Further, the system comprises an action gateway configured to receive scrubbed requests accompanied by tokenized identity proofs and to dispatch the scrubbed requests to one or more external services. Further, the system comprises an oblivious relay, the oblivious relay being operated by an entity independent of the action gateway, configured to forward encapsulated requests from the user device to the action gateway such that the oblivious relay observes a network address but not the scrubbed request and the action gateway observes the scrubbed request but not the network address or the user identity. Further, the system comprises a verified-human registry maintaining identity commitments of verified humans. Further, the system comprises an action-nullifier set server configured to verify and consume tokenized identity proofs and to record an aggregate count corresponding to the action category and the epoch, the action-nullifier set server being devoid of a mapping between the aggregate count and the user identity. Further, the system comprises an entitlement verifier configured to verify a signature of an unlinkable entitlement token issued by a blind-signature protocol without linking the entitlement token to its issuance.

In yet another implementation, an apparatus is disclosed. The apparatus comprises a processor and one or more biometric sensors. The apparatus further comprises a secure enclave to which a Secret-Key (S1) derived from a user biometric captured by the one or more biometric sensors is bound as non-exportable from the secure enclave. The apparatus further comprises a memory storing instructions that, when executed by the processor, cause the apparatus to derive from the Secret-Key (S1), by application of a Function (F1), a tokenized identity proof bound to a context comprising at least an action category and an epoch, the tokenized identity proof being verifiable as originating from a registered verified human in a verified-human registry without revealing the user identity. Further, the instructions cause the apparatus to receive an agentic request from a user. Further, the instructions cause the apparatus to classify the agentic request by intent type via an intent and capability classification and select a tier from among a local-execution tier, a local-resource-match tier, and an external-service tier. Further, the instructions cause the apparatus to form a scrubbed request from the agentic request, excluding personal entities and terms derived from an encrypted preference datastore stored on the apparatus. Further, the instructions cause the apparatus to transmit the scrubbed request and the tokenized identity proof through a split-trust transport that conveys the scrubbed request to an external service without conveying the user identity or the apparatus's network address. Further, the instructions cause the apparatus to receive a response from the external service via the split-trust transport. Further, the instructions cause the apparatus to compose, on the apparatus, an output by ranking and synthesizing the response against the encrypted preference datastore without transmitting the encrypted preference datastore. Further, the instructions cause the apparatus to meter the agentic action by transmitting the tokenized identity proof to an action-nullifier set server for verification and consumption, the action-nullifier set server recording an aggregate count corresponding to the action category and the epoch, the action-nullifier set server being devoid of a mapping between the aggregate count and the user identity.

In still another implementation, a non-transitory computer-readable medium storing instructions is disclosed. The instructions, when executed by a processor coupled to a memory and a secure enclave of a user device, cause the processor to perform operations. The operations comprise computing a Secret-Key (S1) from a user biometric on the user device and binding the Secret-Key (S1) to the secure enclave of the user device such that the Secret-Key (S1) is non-exportable from the secure enclave. Further, the operations comprise deriving, by application of a Function (F1) to the Secret-Key (S1), a tokenized identity proof bound to a context comprising at least an action category and an epoch, verifiable as originating from a registered verified human in a verified-human registry without revealing the user identity. Further, the operations comprise receiving an agentic request from a user. Further, the operations comprise classifying the agentic request by intent type and routing the agentic request, on the user device, to a least-revealing sufficient tier from among a local-execution tier, a local-resource-match tier, and an external-service tier. Further, the operations comprise forming a scrubbed request from the agentic request, excluding personal entities and terms derived from an encrypted preference datastore stored on the user device. Further, the operations comprise transmitting the scrubbed request and the tokenized identity proof through a split-trust transport that conveys the scrubbed request to an external service without conveying the user identity or a network address. Further, the operations comprise composing an output on the user device by ranking and synthesizing a response from the external service against the encrypted preference datastore that is not transmitted. Further, the operations comprise metering the agentic action by transmitting the tokenized identity proof to an action-nullifier set server for verification against the verified-human registry, the action-nullifier set server recording an aggregate count and being devoid of a mapping between the aggregate count and the user identity. Further, the operations comprise contributing a threshold-gated, secret-shared abstraction of the encrypted preference datastore and a record of agentic-action history to an aggregated knowledge graph.

### BRIEF DESCRIPTION OF DRAWINGS

The detailed description is described with reference to the accompanying Figures. The same numbers are used throughout the drawings to refer to features and components.

FIG. 1 illustrates a system architecture depicting three trust zones and the components thereof, in accordance with an embodiment of the present disclosure.

FIG. 2 illustrates an on-device action router decision process for classifying and routing agentic requests, in accordance with an embodiment of the present disclosure.

FIG. 3 illustrates a split-trust action egress showing the flow of a scrubbed request through an oblivious relay and an action gateway to an external service, in accordance with an embodiment of the present disclosure.

FIG. 4 illustrates on-device output composition showing ranking and synthesis of a response against an encrypted preference datastore, in accordance with an embodiment of the present disclosure.

FIG. 5 illustrates anonymous agentic-action metering via context-bound tokenized identity proofs derived from a biometric-anchored Secret-Key, in accordance with an embodiment of the present disclosure.

FIG. 6 illustrates unlinkable premium entitlement via blind-signed token issuance and redemption, in accordance with an embodiment of the present disclosure.

FIG. 7 illustrates preference enrichment from agentic-action history on the user device, in accordance with an embodiment of the present disclosure.

FIG. 8 illustrates a preference-graph contribution to an aggregated knowledge graph via on-device coarsening and threshold disclosure, in accordance with an embodiment of the present disclosure.

The foregoing shall be more apparent from the following more detailed description of the invention.

### DETAILED DESCRIPTION

Reference throughout the specification to “various embodiments,” “some embodiments,” “one embodiment,” or “an embodiment” means that a particular feature, structure, or characteristic described in connection with the embodiment is included in at least one embodiment. Thus, the appearances of the phrases “in various embodiments,” “in some embodiments,” “in one embodiment,” or “in an embodiment” in various places throughout the specification are not necessarily all referring to the same embodiment. Furthermore, the particular features, structures, or characteristics may be combined in any suitable manner in one or more embodiments. The figures and the following detailed description are provided for illustration and are not intended to limit the scope of the invention. The same reference numerals are used throughout the drawings to refer to features and components that appear in more than one figure.

The present invention provides a privacy-preserving personal agent system and method that enables a user to interact with one or more external artificial-intelligence services such that those services receive an authenticated request without receiving the user identity or personal data. In various embodiments, the system employs a combination of biometric-anchored identity, split-trust transport, on-device composition, anonymous action metering, unlinkable premium entitlement, and verified-human-gated collective-intelligence aggregation. These components work together to ensure that no single party in the system observes both the user identity and the content of any agentic action. The following detailed description is organized by reference to the accompanying figures, each of which illustrates a different functional aspect of the invention.

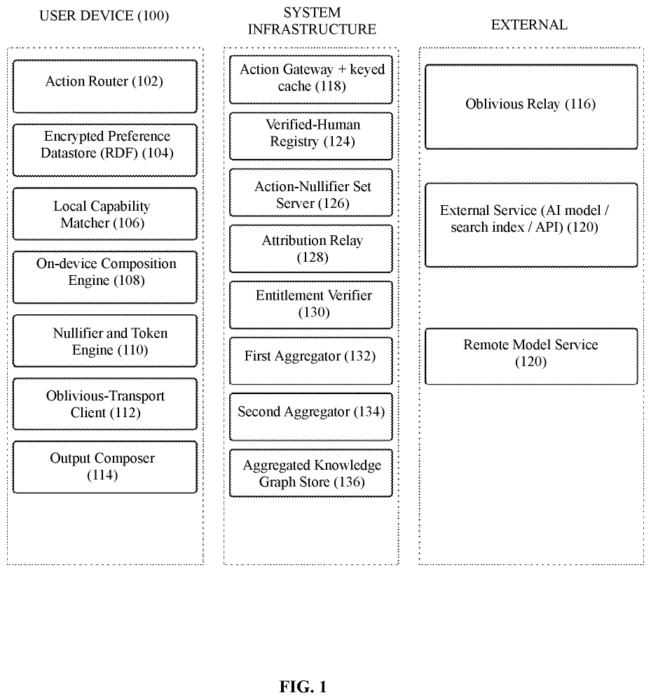

Referring now to FIG. 1, the system architecture of the present invention is organized into three trust zones: an on-device zone, an operator-infrastructure zone, and an external zone. Each trust zone is defined by the nature and extent of the information observable by the entities within it. This architectural separation ensures that user identity, request content, and personal preferences are never simultaneously available to any single party, thereby providing privacy as a structural property of the system rather than a matter of organizational policy.

The on-device zone resides entirely on a user device (100) having a secure enclave or trusted execution environment. The user device (100) may comprise, for example, a smartphone such as an Apple iPhone or Android device, a tablet, a laptop, a desktop computer, or any computing device equipped with a processor, one or more biometric sensors, and a hardware-isolated secure enclave. In one embodiment, the secure enclave comprises a hardware-isolated execution environment selected from the group consisting of an Apple Secure Enclave Processor, an Android StrongBox Keymaster, an ARM TrustZone, an Intel SGX environment, an AMD SEV environment, and a hardware security module. The secure enclave is configured to store one or more cryptographic keys as non-exportable from the secure enclave, meaning that once a key is bound to the secure enclave, it cannot be read, copied, or transmitted outside the enclave boundary by any software process, including the operating system.

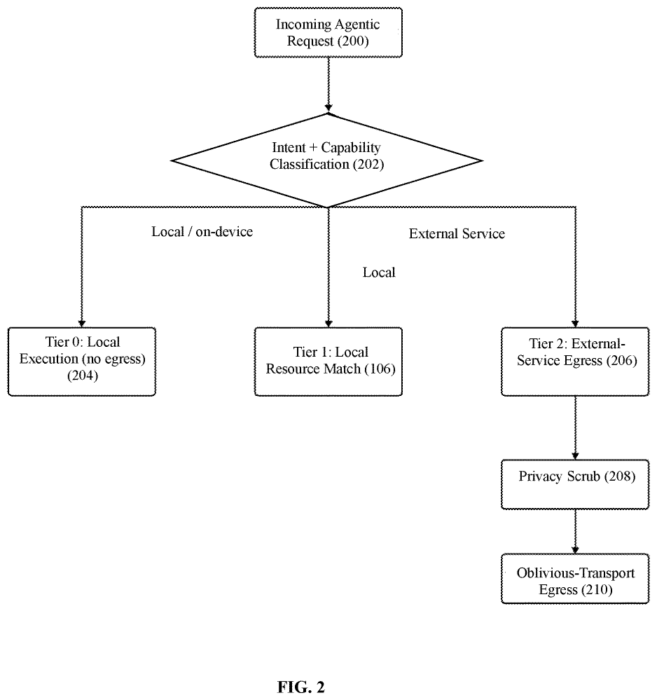

The on-device zone of the user device (100) includes the following components, each of which performs a distinct function in the privacy-preserving agent pipeline. An action router (102) receives each agentic request from the user and classifies it by intent type to determine the appropriate processing tier, as described in further detail with reference to FIG. 2. An encrypted preference datastore (104) stores the user's personal preferences, interests, avoidance constraints, engagement history, and other personal context in an encrypted resource-description-framework (RDF) triplestore format on the user device (100). The encrypted preference datastore (104) is never transmitted to any external party and serves as the local knowledge base against which all personalization, ranking, and composition operations are performed. For example, if a user named Sarah frequently searches for vegetarian recipes and has indicated an avoidance of content related to a particular food allergen, the encrypted preference datastore (104) stores these preferences as RDF triples such as (Sarah, interested_in, “vegetarian recipes”) and (Sarah, avoids, “peanut-containing recipes”). These triples are used locally to personalize results but are never included in any request that leaves the user device (100).

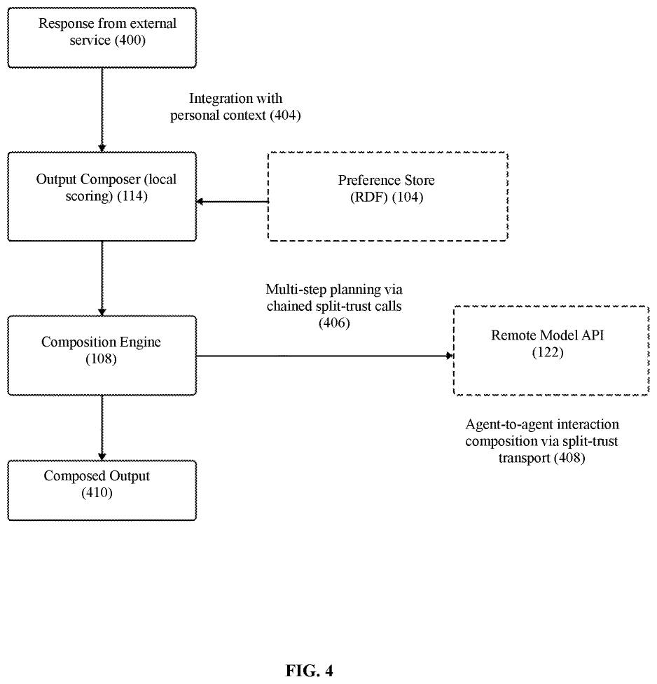

A local capability matcher (106) maintains an encrypted on-device catalog of resources, models, and capabilities available locally on the user device (100). The local capability matcher (106) is consulted by the action router (102) to determine whether a given agentic request can be resolved entirely from local resources without any network egress, as described in further detail with reference to FIG. 2. A composition engine (108) performs the core computational work of the agent, comprising one or more on-device language models and a chained reasoning runtime. The composition engine (108) performs retrieval-augmented generation, document integration, multi-step planning, and agent-to-agent interaction mediation, as described in further detail with reference to FIG. 4. In one embodiment, the composition engine (108) executes a compact language model on the device processor or a dedicated neural processing unit, enabling the device to perform natural-language understanding, generation, and reasoning without transmitting any user data. For example, if Sarah asks her personal agent to “summarize the three best Italian restaurants near me for a dinner with my parents who are vegetarian,” the composition engine (108) generates the summary locally using results retrieved from an external search service and personal context from the encrypted preference datastore (104), such as her parents' dietary restrictions and her past dining preferences.

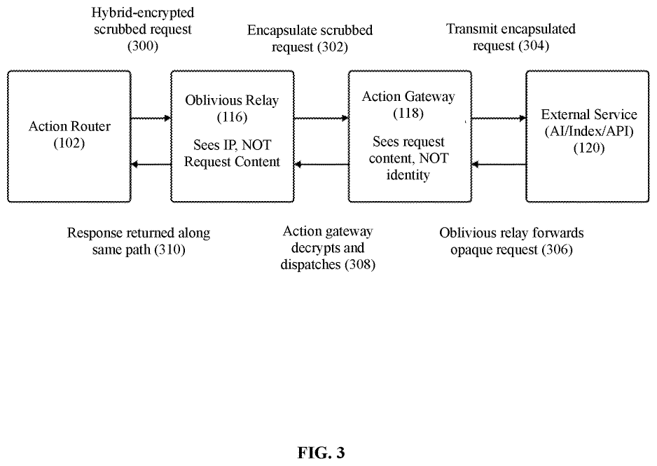

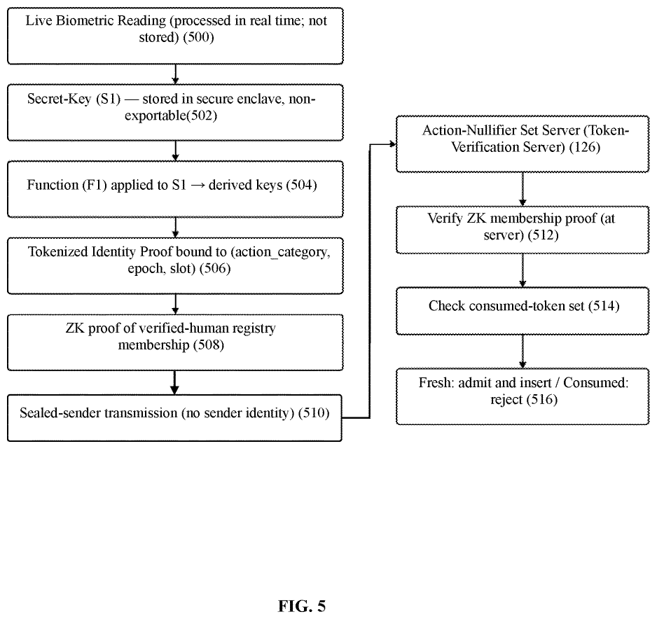

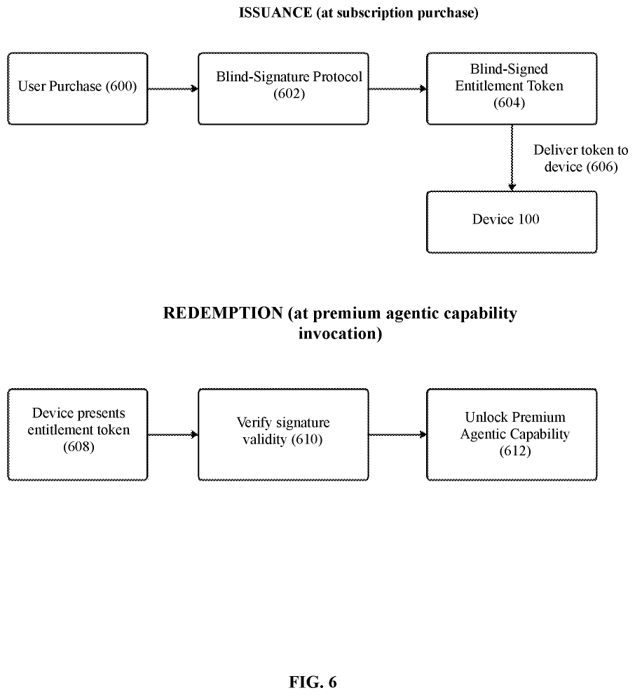

A nullifier and token engine (110) is responsible for deriving biometric-anchored cryptographic keys and generating tokenized identity proofs and entitlement tokens, as described in further detail with reference to FIG. 5 and FIG. 6. The nullifier and token engine (110) operates within the secure enclave of the user device (100) to ensure that the Secret-Key (S1) and all derived keys remain non-exportable. An oblivious-transport client (112) manages the formation, encapsulation, and transmission of scrubbed requests through the split-trust transport, as described in further detail with reference to FIG. 3. The oblivious-transport client (112) encapsulates each scrubbed request under a public key of the action gateway (118) using a hybrid public-key encryption scheme such that only the intended recipient can decrypt the request content. An output composer (114) receives the composed output from the composition engine (108) and presents it to the user in the appropriate format, whether as a text response, a formatted document, a calendar entry, a transaction confirmation, or any other output type appropriate to the agentic request.

The operator-infrastructure zone operates as a token orchestrator that stores no personally identifiable information. This zone includes the following components. An action gateway (118) receives scrubbed requests accompanied by tokenized identity proofs and dispatches the scrubbed requests to one or more external services (120). The action gateway (118) maintains a content-keyed cache shared across users. When the external service (120) is a search index or other read-only resource, the action gateway (118) may serve a cached response for a previously seen normalized request string, thereby reducing latency and external-service load without compromising privacy, because the cache is keyed by the generic content of the scrubbed request rather than by any user identity. For example, if multiple users submit the scrubbed query “best practices for container orchestration,” the action gateway (118) may serve a cached result rather than dispatching a redundant request to the external service (120).

A verified-human registry (124) maintains a data structure, such as a Merkle tree, of identity commitments of verified humans. Each identity commitment is derived from a user's biometric-anchored Secret-Key (S1) through the Function (F1) pipeline, and the commitment is stored in the registry without any link to the user's real-world identity. The verified-human registry (124) enables the system to confirm that a given tokenized identity proof originates from a registered verified human without revealing which specific human. An action-nullifier set server (126) is configured to verify and consume tokenized identity proofs and to record an aggregate count corresponding to the action category and the epoch. The action-nullifier set server (126) is devoid of a mapping between the aggregate count and the user identity, meaning that it records how many actions of a given category occurred within a given epoch but never records which user performed any individual action. An attribution relay (128) facilitates verified-human engagement attribution without revealing user identity, enabling content creators and service providers to receive anonymized feedback signals.

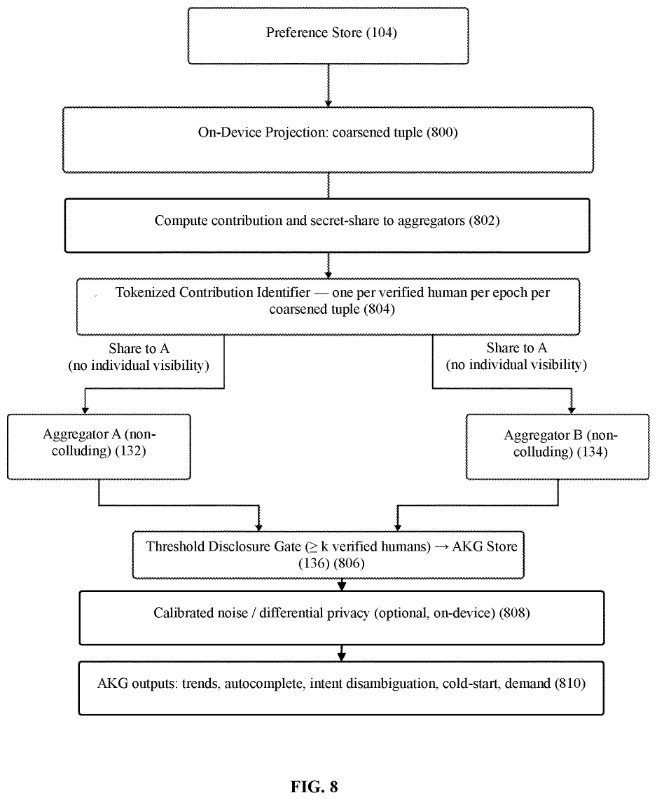

An entitlement verifier (130) is configured to verify a signature of an unlinkable entitlement token (604) issued by a blind-signature protocol (602) without linking the entitlement token to its issuance, as described in further detail with reference to FIG. 6. A first aggregator (132) and a second aggregator (134), operated by independent entities that do not collude, cooperate to maintain an aggregated knowledge graph store (136). The first aggregator (132) and the second aggregator (134) receive secret-shared contributions from user devices and jointly compute aggregate counts and trends without either aggregator being able to observe any individual contribution value, as described in further detail with reference to FIG. 8. The aggregated knowledge graph store (136) stores the resulting aggregate signals, including trending action types, emerging patterns, demand signals, and query co-occurrence data, all derived exclusively from verified, deduplicated human contributors.

The external zone includes an oblivious relay (116), one or more external services (120), and a remote model service (122). The oblivious relay (116) is operated by an entity that is independent of and does not collude with the action gateway (118). The oblivious relay (116) is configured to forward encapsulated requests from the user device (100) to the action gateway (118) such that the oblivious relay (116) observes the network address of the user device (100) but not the scrubbed request content, because the request is encapsulated under the action gateway's public key before reaching the relay. The one or more external services (120) may each comprise an artificial-intelligence model, a search index, a programmable interface, or any other computer-implemented service. The external service (120) receives a generic request from the action gateway (118) without any indication of which user originated the request. A remote model service (122) provides premium synthesis and reasoning capability, such as access to a frontier artificial-intelligence model, and operates under a zero-retention arrangement whereby the remote model service (122) does not retain any request or response content after processing.

The architectural separation among the three trust zones ensures the following properties. The user device (100) performs all classification, ranking, composition, and synthesis locally and emits, for an external-service request, only a scrubbed request and an anonymous budget nullifier. The oblivious relay (116) observes the user's network address but never request content, identity, or responses. The action gateway (118) observes scrubbed request text transiently and content-keyed cache entries where applicable, but never a network address, user identity, the encrypted preference datastore (104), a selected response, or any action-to-human mapping. The external service (120) observes only a generic request from the action gateway (118). Consequently, compromise of any single party yields either content without identity or identity without content, but never both, and never an action history linking actions to a specific user.

Referring now to FIG. 2, the on-device action routing process is described. When the user device (100) receives an incoming agentic request (200) from the user, the action router (102) performs an intent and capability classification (202) entirely on the user device (100). The intent and capability classification (202) analyzes the agentic request to determine its intent type and to select the least-revealing sufficient processing tier. The intent type may be one of information retrieval, document composition, calendar or coordination action, transaction, multi-step planning, agent-to-agent interaction, or another category specified by the device application. The classification is performed locally so that no external party learns even the category of the user's request.

Based on the intent and capability classification (202), the action router (102) selects one of three processing tiers. The first tier is a local-execution tier (204), in which the agentic request is fully resolvable on the user device (100) with no network egress whatsoever. For example, if Sarah asks her personal agent “What time is my dentist appointment tomorrow?”, and the encrypted preference datastore (104) contains a calendar entry with the appointment details, the action router (102) routes this request to the local-execution tier (204) and the answer is composed entirely on the device without any data leaving the user device (100). The second tier is a local-resource-match tier resolved by the local capability matcher (106), in which the agentic request is matched against an encrypted on-device catalog of locally available resources, models, and data. For example, if Sarah asks “Show me the Italian recipe I saved last week,” and the recipe is stored locally in the encrypted preference datastore (104), the local capability matcher (106) identifies the match and the request is served without network egress. The third tier is an external-service tier (206), in which the agentic request requires interaction with one or more external services (120) and must therefore pass through the split-trust transport described with reference to FIG. 3.

The intent and capability classification (202) applies two gates to make the tier-selection decision. A freshness gate evaluates whether time-sensitive markers are present in the agentic request or whether the local knowledge stored in the encrypted preference datastore (104) has become stale with respect to the request topic. If the agentic request contains time-sensitive markers, such as “latest,” “today's,” “breaking,” or “current price of,” or if the locally stored knowledge for the relevant topic has not been updated within a predefined freshness window, the freshness gate routes the agentic request to the external-service tier (206) because a local response would be unreliable. For example, if Sarah asks “What is the current stock price of Apple?”, the freshness gate determines that this request requires real-time data that the device cannot provide from its local store, and routes the request to the external-service tier (206). A capability gate evaluates whether the agentic request is resolvable by the local resources of the user device (100), including the encrypted preference datastore (104), the local capability matcher (106), and any on-device language models available to the composition engine (108). If the request is resolvable locally, the capability gate routes it to the local-resource-match tier served by the local capability matcher (106) or to the local-execution tier (204), thereby minimizing data egress from the user device (100). The action router (102) thereby simultaneously advances privacy and reduces operating cost by minimizing network egress.

When the action router (102) selects the external-service tier (206), the agentic request is subjected to a privacy scrub (208) before any data leaves the user device (100). The privacy scrub (208) removes personal entities, prior-action context, and any term derived from the encrypted preference datastore (104) from the agentic request to form a scrubbed request. For example, if Sarah asks “Find me a vegetarian restaurant near my parents' house in Brooklyn for my mother's birthday dinner next Saturday,” the privacy scrub (208) transforms this request into a scrubbed request such as “vegetarian restaurant Brooklyn” by removing the personal references to “my parents' house,” “my mother's birthday,” and “next Saturday,” and retaining only the generic, non-identifying search terms. The scrubbed request is then passed to the oblivious-transport client (112) for oblivious-transport egress (210) through the split-trust transport described with reference to FIG. 3.

In one embodiment, the system supports a maximum-privacy mode that provides an even higher level of privacy protection at the cost of reduced personalization. When the maximum-privacy mode is enabled, the system disables on-device ranking and synthesis against the encrypted preference datastore (104) and transmits only a minimal scrubbed request through the split-trust transport. In the maximum-privacy mode, the user receives raw, unpersonalized results from the external service (120), because the composition engine (108) does not apply any preference-based ranking or context integration. This mode is useful for users who desire the strongest possible privacy guarantees and are willing to forgo the convenience of personalized results. The user may toggle the maximum-privacy mode on or off through a user-accessible control on the user device (100).

Referring now to FIG. 3, the split-trust action egress process is described. When the action router (102) has selected the external-service tier (206) and the privacy scrub (208) has produced a scrubbed request, the oblivious-transport client (112) on the user device (100) initiates the split-trust transport to convey the scrubbed request to an external service (120) without conveying the user identity or the network address of the user device (100) to the entity that observes the request content. The split-trust transport is so named because trust is split between two non-colluding parties: a first party, the oblivious relay (116), that observes the network address but not the request content, and a second party, the action gateway (118), that observes the request content but not the network address or the user identity. Because these two parties are operated by independent entities that do not collude, no single party observes both the user identity and the scrubbed request.

In the first step (300), the oblivious-transport client (112) forms the scrubbed request by taking the output of the privacy scrub (208) and preparing it for encapsulation. The scrubbed request contains only the generic, non-identifying content of the agentic request, with all personal entities, prior-action context, and terms derived from the encrypted preference datastore (104) removed. The scrubbed request may include, for example, a search query string, a document-composition prompt, or a structured instruction for an external application programming interface. No term of the encrypted preference datastore (104) appears in the scrubbed request.

In the second step (302), the oblivious-transport client (112) encapsulates the scrubbed request under a public key associated with the action gateway (118) using a hybrid public-key encryption scheme. In one preferred embodiment, this encapsulation is performed using Hybrid Public Key Encryption (HPKE) as specified in RFC 9180. The encapsulation produces an opaque encapsulated request that can be decrypted only by the action gateway (118) using its corresponding private key. The oblivious relay (116) cannot decrypt the encapsulated request because it does not possess the action gateway's private key. This cryptographic encapsulation ensures that the first party (the oblivious relay (116)) observes only an opaque blob of ciphertext and cannot access the scrubbed request content.

In the third step (304), the oblivious-transport client (112) transmits the opaque encapsulated request to the oblivious relay (116). The oblivious relay (116) is operated by an entity independent of the action gateway (118), for example, a content delivery network provider, a cloud infrastructure provider, or any other entity that has agreed to operate the relay service without sharing data with the action gateway operator. In the fourth step (306), the oblivious relay (116) forwards the opaque encapsulated request to the action gateway (118). The oblivious relay (116) observes the network address (for example, the IP address) of the user device (100) because it receives the request directly from the device, but the relay does not observe the scrubbed request content because the request is encrypted under the action gateway's public key. The oblivious relay (116) strips the originating network address before forwarding the encapsulated request to the action gateway (118), so that the action gateway (118) does not learn the network address of the user device (100). In one preferred embodiment, the transport implements Oblivious HTTP (OHTTP) as specified in RFC 9458 over HPKE.

In the fifth step (308), the action gateway (118) receives the encapsulated request from the oblivious relay (116), decrypts it using the action gateway's private key, and thereby obtains the scrubbed request in plaintext. The action gateway (118) observes the scrubbed request content but does not observe the network address of the user device (100) or any user identity, because the oblivious relay (116) has stripped the originating network address. The action gateway (118) dispatches the scrubbed request to the appropriate external service (120). Optionally, where the external service (120) is a search index or other read-only resource, the action gateway (118) may serve a response from a content-keyed cache keyed by a normalized version of the request string and shared across all users. In the sixth step (310), the response from the external service (120) is returned along the same path: the action gateway (118) encapsulates the response and transmits it back through the oblivious relay (116) to the user device (100). The response is received at the user device (100) via the split-trust transport in encapsulated form.

It is expressly disclosed that, for the necessary case of external execution, request content is rendered unlinkable to the user rather than invisible to the servicing external service (120). The action gateway (118) and the external service (120) do observe the content of the scrubbed request in order to process it and return a result. The privacy property of the system is that this content cannot be linked to any user identity because the split-trust transport structurally separates the identity-bearing information (held by the oblivious relay (116)) from the content-bearing information (held by the action gateway (118)). For example, if Sarah submits a scrubbed query “vegetarian restaurant Brooklyn” through the split-trust transport, the oblivious relay (116) knows that a request came from Sarah's IP address but does not know what was asked, while the action gateway (118) knows that someone asked about vegetarian restaurants in Brooklyn but does not know who asked. No single party possesses both pieces of information.

Referring now to FIG. 4, the on-device output composition process is described. Upon receipt of a response (400) from the external service (120) via the split-trust transport, the user device (100) performs composition operations entirely on the device to produce a composed output (410) that is personalized to the user's preferences and context. The composition operations are performed by the output composer (114) and the composition engine (108) operating against the encrypted preference datastore (104). A hard constraint enforced throughout this process requires that no term of the encrypted preference datastore (104) appears in any egress request. All personalization and composition are applied only after the response returns to the user device (100), so that the scrubbed request sent through the split-trust transport carries no preference term.

For an information-retrieval request, the output composer (114) performs a ranking operation (402) in which it ranks merged organic results from the external service (120) and any locally available candidates against triples stored in the encrypted preference datastore (104). The triples used for ranking include those of type interested_in, which reflect the user's expressed and inferred interests, those of type avoids, which reflect topics or sources the user has indicated should be deprioritized or excluded, and those of type engagement_history, which reflect the user's past interactions and preferences. The composition engine (108) then performs retrieval-augmented generation over the ranked result snippets to produce a synthesized cited answer. For example, if Sarah searches for “best hiking trails in Colorado” and the encrypted preference datastore (104) contains the triples (Sarah, interested_in, “dog-friendly trails”) and (Sarah, avoids, “trails requiring technical climbing equipment”), the output composer (114) re-ranks the external search results to prioritize dog-friendly trails and deprioritize those requiring technical gear, and the composition engine (108) generates a synthesized answer with citations to the source results. This entire ranking and synthesis operation occurs on the user device (100), and the external search service never learns about Sarah's dog or her equipment preferences.

For a document-composition request, the composition engine (108) performs a document integration operation (404) in which it integrates the external model's response with personal context held in the encrypted preference datastore (104) to produce a final document, message, or other output. The personal context may include the user's writing style, prior documents, relationships, calendar context, and other information relevant to producing a personalized output. None of this personal context is transmitted to the external service (120). For example, if Sarah asks her personal agent to “draft a thank-you note to my colleague David for the project presentation,” the scrubbed request sent to the external service (120) might be “draft a professional thank-you note for a colleague regarding a project presentation.” The external service returns a generic template response. The composition engine (108) then integrates this response with Sarah's personal context, such as her relationship with David, the specific project name, and her preferred communication style, all sourced from the encrypted preference datastore (104), to produce a personalized final note. The encrypted preference datastore (104) is never transmitted in this process.

For a multi-step planning request, the composition engine (108) performs a multi-step planning operation (406) in which it decomposes a high-level user request into sub-tasks and chains multiple transmissions through the split-trust transport to one or more external services (120). Intermediate outputs from each sub-task are synthesized on the user device (100), and no external service (120) observes the full plan, the inter-task context, or the outputs of other subtasks. For example, if Sarah asks her personal agent to “plan a surprise birthday dinner for my husband next Friday, find a French restaurant, make a reservation, and order a cake from a local bakery,” the composition engine (108) decomposes this into sub-tasks: (1) search for French restaurants, (2) check availability and make a reservation, and (3) find a local bakery and order a cake. Each sub-task is independently scrubbed and routed through the split-trust transport. The restaurant search service learns only “French restaurant [city]” and never learns about the birthday or the husband. The bakery service learns only “birthday cake order” and never learns who the celebration is for. The composition engine (108) synthesizes the results of all three sub-tasks on the user device (100) to present Sarah with a unified plan.

For an agent-to-agent interaction, the composition engine (108) performs an agent-to-agent mediation operation (408) in which the user's personal agent constructs requests and interprets responses to and from a counterparty agent via the split-trust transport. In this mode, the user's agent interacts with another party's personal agent, such as a vendor's sales agent, a counterparty's scheduling agent, or a service provider's customer-support agent. Both agents mediate through respective oblivious transports such that neither party's identity, encrypted preference datastore (104), or full context is exposed to the other. The result of the agent-to-agent negotiation is composed on each respective user device. For example, if Sarah's personal agent negotiates a meeting time with her colleague's personal agent, Sarah's agent discloses only the proposed time slots through the split-trust transport, without revealing Sarah's full calendar, location, or other scheduling constraints stored in the encrypted preference datastore (104). The counterparty's agent similarly discloses only the minimum information necessary to reach a scheduling agreement.

In one embodiment, the system supports a premium tier in which the same split-trust transport routes prompts and contextual data to the remote model service (122) for enhanced synthesis and reasoning. The remote model service (122) may comprise a frontier artificial-intelligence model capable of more sophisticated generation, analysis, and reasoning than the on-device models available in the composition engine (108). The remote model service (122) operates under a zero-retention arrangement, whereby the remote model service (122) does not retain any request or response content after processing. The prompts and snippets routed to the remote model service (122) are scrubbed in the same manner as requests to other external services (120) and are transmitted through the split-trust transport, so that the remote model service (122) observes the content but not the user identity. Access to the premium tier is gated by unlinkable entitlement tokens issued under a blind-signature protocol, as described in further detail with reference to FIG. 6.

In every composition mode described above, the encrypted preference datastore (104) remains on the user device (100) and is never transmitted. The personalization, ranking, context integration, and synthesis operations all occur locally on the user device (100) after the response from the external service (120) has been received. The composed output (410) is presented to the user by the output composer (114) in the format appropriate to the request type, whether as a text answer, a formatted document, a calendar entry, a transaction confirmation, a multi-step plan summary, or a negotiation outcome. The agentic request may be one of a search query producing a synthesized cited answer, a document-composition request producing a final document integrated with on-device personal context, a calendar-coordination request producing a scheduled event without revealing the user's calendar to an external party, a financial-transaction request executed with verified-human authorization, a multi-step planning request executed by chaining a plurality of transmissions through the split-trust transport, and an agent-to-agent interaction in which a counterparty agent does not learn the user identity or the encrypted preference datastore (104).

Referring now to FIG. 5, the anonymous agentic-action metering process is described. Expensive agentic actions, such as queries to external artificial-intelligence models, document-composition requests, and financial transactions, consume shared resources and must be metered to prevent abuse. In conventional systems, metering is performed by associating each action with a user account, thereby creating a complete action history linked to the user's identity. The present invention meters agentic actions without identifying the user, by means of context-bound tokenized identity proofs derived from a biometric-anchored Secret-Key (S1) by application of a Function (F1). The metering process is performed jointly by the nullifier and token engine (110) on the user device (100) and the action-nullifier set server (126) in the operator-infrastructure zone, with the verified-human registry (124) providing the membership verification basis.

In the first step, the user device (100) receives a live biometric reading (500) from one or more biometric sensors on the device. The biometric reading (500) may comprise, for example, a facial scan captured by a front-facing camera, a fingerprint scan captured by a fingerprint sensor, an iris scan, or any other biometric modality supported by the device hardware. The biometric reading (500) is processed in real time on the user device (100) and is not stored after key derivation is complete. The nullifier and token engine (110), operating within the secure enclave of the user device (100), computes a Secret-Key (S1) (502) from the biometric reading (500). The Secret-Key (S1) (502) is bound to the secure enclave such that the Secret-Key (S1) (502) is non-exportable from the secure enclave. This means that no software process, including the operating system of the user device (100), can read, copy, or transmit the Secret-Key (S1) (502) outside the boundary of the secure enclave. The Secret-Key (S1) (502) and the Function (F1) terminology used herein are the same vocabulary at the same level of generality as the commonly-owned granted U.S. Pat. No. 11,582,032 B2 and U.S. Pat. No. 12,079,367 B2 cross-referenced in this application.

In the second step, the nullifier and token engine (110) derives one or more keys from the Secret-Key (S1) (502) by application of a Function (F1) (504). In one preferred embodiment, the Function (F1) (504) comprises a two-stage key-derivation chain. In the first stage, a domain-separated derived key, referred to as zkSecret, is computed by application of a key-derivation function (KDF) over a domain-separation context string. By way of non-limiting example, zkSecret may be computed as zkSecret=HKDF(S1, info: “graph/v1”, length: 32), where HKDF denotes the HMAC-based Key Derivation Function. In the second stage, a nullifier-class key, referred to as nullifierKey, is computed by application of a zero-knowledge-friendly hash function to the zkSecret. By way of non-limiting example, nullifierKey may be computed as nullifierKey=Poseidon([zkSecret, “0”]), where Poseidon denotes a zero-knowledge-friendly hash function designed for efficient evaluation within arithmetic circuits used in zero-knowledge proof systems. The choice of HKDF and Poseidon is illustrative and non-limiting. Any key-derivation function and any zero-knowledge-friendly hash function of equivalent security may be substituted without departing from the scope of the invention.

In the third step, the nullifier and token engine (110) generates a tokenized identity proof (506) bound to a context comprising at least an action category and an epoch. The tokenized identity proof (506) comprises a cryptographic hash of (i) a key derived from the Secret-Key (S1) (502) by application of the key-derivation function (504), (ii) a context string comprising the action category, (iii) the epoch, and (iv) a slot within a range [0, N) where N is dependent on the action category and an entitlement tier. In one preferred embodiment, the tokenized identity proof (506), referred to as an action nullifier, is computed as action_nullifier=Poseidon(nullifierKey ∥“agent:”∥action_category∥epoch∥slot), where ∥ denotes concatenation. The action category identifies the type of agentic action being performed, for example “search,” “document-composition,” “calendar,” or “financial-transaction.” The epoch defines a time window, for example a calendar day, a week, or a month, during which the budget is valid. The slot is an integer in the range [0, N), where N represents the maximum number of actions of that category permitted within the epoch for the user's entitlement tier. For example, if Sarah has a standard-tier subscription that permits ten search queries per day, then N equals ten for the action category “search” and the epoch corresponding to the current day, and the slots are numbered zero through nine. Each slot may be consumed at most once per epoch, thereby enforcing the budget.

In the fourth step, the nullifier and token engine (110) generates a zero-knowledge proof (508) of membership in the verified-human registry (124) without revealing the user identity. The zero-knowledge proof (508) demonstrates that the tokenized identity proof (506) was derived from a Secret-Key (S1) (502) corresponding to an identity commitment registered in the verified-human registry (124), without disclosing which specific identity commitment. In one preferred embodiment, the zero-knowledge proof (508) comprises a non-interactive zero-knowledge argument of knowledge, such as a Groth16 SNARK over the BN254 elliptic curve. The choice of Groth16 and BN254 is illustrative and non-limiting. Any non-interactive zero-knowledge argument of knowledge, including alternative zk-SNARK constructions or zk-STARK constructions, of equivalent security and completeness may be substituted. The verified-human registry (124) maintains a data structure, such as a Merkle tree, of identity commitments, and the zero-knowledge proof (508) proves that the user's identity commitment is a leaf of the Merkle tree without revealing which leaf.

In the fifth step, the nullifier and token engine (110) transmits the tokenized identity proof (506) and the zero-knowledge proof (508) to the action-nullifier set server (126) via a sealed-sender transport (510) that conceals the sender network identity. The sealed-sender transport (510) ensures that the action-nullifier set server (126) does not learn the network address of the user device (100), thereby preventing the server from correlating tokenized identity proofs with network-level identifiers. In one preferred embodiment, the sealed-sender transport (510) is implemented by a protocol that conceals the sender identity at the transport layer, for example as established by a commonly-owned messaging foundation. Any transport mechanism providing equivalent sender-identity concealment is within the scope of the invention.

Upon receiving the tokenized identity proof (506) and the zero-knowledge proof (508), the action-nullifier set server (126) performs a three-step verification process. First, the action-nullifier set server (126) verifies the zero-knowledge proof (508) to confirm that the tokenized identity proof (506) originates from a registered verified human in the verified-human registry (124), a step referred to as verify membership (512). If the membership proof is invalid, the action is rejected. Second, the action-nullifier set server (126) checks the tokenized identity proof (506) against a compact set of previously consumed tokenized identity proofs, a step referred to as check consumed set (514). Because each tokenized identity proof (506) is deterministically derived from the Secret-Key (S1) (502), the action category, the epoch, and the slot, the same user submitting the same slot for the same action category in the same epoch will produce an identical tokenized identity proof (506). Third, based on the outcome of the consumed-set check, the action-nullifier set server (126) either admits the action and inserts the tokenized identity proof (506) into the consumed set, or rejects the action if the tokenized identity proof (506) has already been consumed (516). When the user has consumed all N slots for a given action category within an epoch, no fresh tokenized identity proofs can be generated for that category, and further actions of that category are rejected until the next epoch begins.

The encoding of the action category in the context binding of the tokenized identity proof (506) permits independent budgets across action categories. For example, a user may have an information-retrieval budget of twenty queries per day and a separate document-composition budget of five compositions per day. Because the action category is included in the hash computation of the tokenized identity proof (506), a tokenized identity proof generated for the “search” category cannot be used to authorize a “document-composition” action, and vice versa. The entitlement tier further controls the value of N for each action category, enabling premium subscribers to receive higher budgets. The action-nullifier set server (126) records an aggregate count corresponding to the action category and the epoch, reflecting the total number of actions of that category performed by all users within that epoch. The action-nullifier set server (126) is devoid of a mapping between the aggregate count and the user identity, meaning that the server learns a count and never an identity. For example, the server may record that 14,523 search queries were metered on a given day, but it cannot determine which user performed any specific query or how many queries any individual user performed.

Referring now to FIG. 6, the unlinkable premium entitlement process is described. The system supports a premium tier that provides enhanced agentic capabilities, such as access to frontier artificial-intelligence models via the remote model service (122), higher action budgets per epoch, and additional composition features. In conventional systems, premium capability is gated by a subscription tied to a user account, creating a direct link between the billing record and the usage history. The present invention gates premium capability using unlinkable blind-signed entitlement tokens, such that billing for the premium capability is cryptographically unlinkable to agentic usage thereof. The process comprises two phases: an issuance phase that occurs at the time of subscription purchase, and a redemption phase that occurs each time the user invokes a premium capability.

In the issuance phase, when the user purchases a subscription or acquires premium entitlement, the system issues one or more entitlement tokens (604) to the user device (100) by a blind-signature protocol (602). The blind-signature protocol (602) is a cryptographic protocol in which an issuer signs a token without observing its content. In one preferred embodiment, the blind-signature protocol (602) is implemented as a Chaumian blind-signature protocol, in the manner of Privacy Pass. The process begins with a user purchase (600), in which the user pays for a premium subscription through a standard payment channel. The payment channel records the financial transaction and associates it with the user's billing identity. However, the entitlement tokens (604) that are issued as a result of this purchase are generated using the blind-signature protocol (602) such that the issuer signs each entitlement token (604) without observing its content. This means that the issuer knows that a valid subscription was purchased but does not know the specific content of the entitlement tokens (604) that were signed. The signed entitlement tokens (604) are then delivered to the user device (100) and stored locally. For example, if Sarah purchases a monthly premium subscription, the system issues thirty entitlement tokens (604) to her device, one for each day of the month, each blind-signed by the issuer without the issuer knowing which specific tokens were signed for Sarah's subscription.

In the redemption phase, when the user invokes a premium capability, the user device (100) presents an entitlement token (604) to the entitlement verifier (130). The entitlement verifier (130) verifies the signature of the entitlement token (604) to confirm that it was signed by a legitimate issuer, a step referred to as verify signature (610). If the signature is valid, the entitlement verifier (130) unlocks the premium agentic capability (612), enabling the user to access the requested premium feature. The entitlement verifier (130) cannot link the entitlement token (604) to its issuance because the blind-signature protocol (602) ensures that the token content was never observed by the issuer during signing. Consequently, the entitlement verifier (130) knows that a valid premium token is being redeemed but cannot determine which user purchased the token or when it was issued. Subscription billing and agentic usage are thereby cryptographically unlinkable. For example, when Sarah requests a premium document-composition operation that requires access to a frontier model via the remote model service (122), her device presents one of her entitlement tokens (604) to the entitlement verifier (130). The verifier confirms the token is validly signed and unlocks the premium capability, but it cannot determine that this particular token belongs to Sarah or link it to her subscription purchase.

In one embodiment, the entitlement tokens (604) may be scoped to particular agentic capabilities. For example, a premium subscription may include tokens scoped to premium document composition by a frontier model, tokens scoped to higher action budgets for a given action category, and tokens scoped to premium multi-step planning with extended chaining depth. The scoping is encoded within the token content prior to blind signing, so that the entitlement verifier (130) can determine the capability scope of a redeemed token without learning the identity of the redeemer. This enables tiered premium offerings in which different capabilities are priced and metered independently, all while maintaining the cryptographic unlinkability between billing and usage.

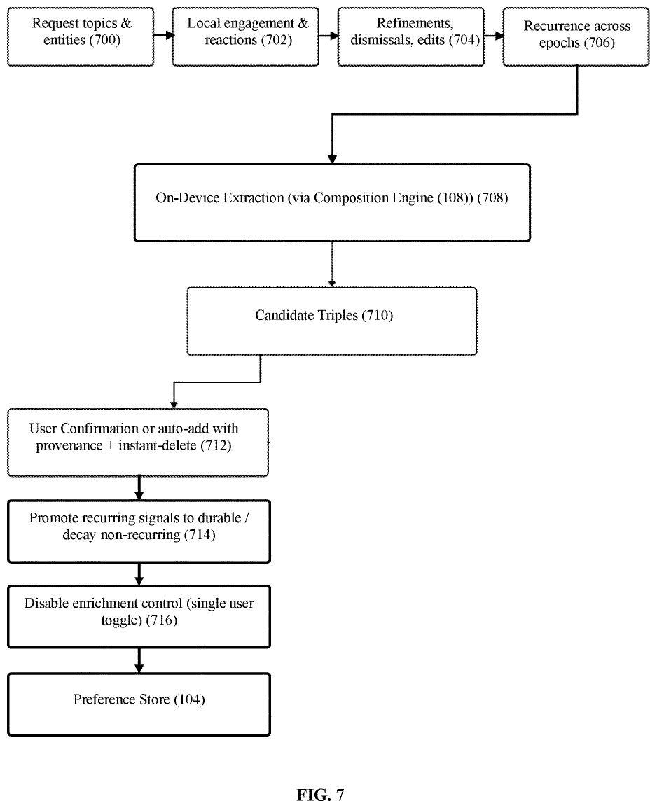

Referring now to FIG. 7, the preference enrichment process is described. After each agentic interaction, the user device (100) enriches the encrypted preference datastore (104) entirely on the device by extracting candidate triples from the interaction and adding them to the datastore subject to user confirmation. This enrichment process ensures that the encrypted preference datastore (104) grows more accurate and comprehensive over time, enabling increasingly personalized composition without ever transmitting any enrichment datum from the user device (100). The enrichment process is performed by the composition engine (108) and operates on four categories of input signals.

The first input category is request topics and entities (700), comprising the content of the agentic request itself. The composition engine (108) performs on-device extraction (708) to identify topics, entities, and intent patterns from the request and generates candidate triples of type interested_in. For example, if Sarah asks her personal agent to “find a dog-friendly hiking trail with waterfalls near Denver,” the extraction process identifies the entities “dog-friendly,” “hiking trail,” “waterfalls,” and “Denver” and generates candidate triples such as (Sarah, interested_in, “dog-friendly hiking”), (Sarah, interested_in, “waterfalls”), and (Sarah, interested_in, “Denver outdoor activities”). The second input category is local engagement signals and user reactions (702), comprising the user's interactions with the composed outputs, such as clicks, saves, shares, time spent reading, and explicit feedback (thumbs up, thumbs down). The composition engine (108) extracts candidate triples of type engagement_history from these signals. For example, if Sarah saves a particular restaurant recommendation to her favorites, the extraction process generates a triple such as (Sarah, engagement_history, “saved Italian restaurant recommendation”).

The third input category is refinements, dismissals, and edits (704), comprising the user's corrections and adjustments to composed outputs. The composition engine (108) extracts candidate triples of type avoids and other constraint triples from these signals. For example, if Sarah dismisses a search result about a restaurant because it is not wheelchair-accessible, the extraction process generates a triple such as (Sarah, avoids, “non-wheelchair-accessible venues”). The fourth input category is recurrence patterns across epochs (706), comprising patterns that emerge over multiple interactions and time periods. The composition engine (108) analyzes these patterns to distinguish between transient interests and durable preferences. Signals that recur across multiple epochs are promoted to durable triples, while signals that appear only once or infrequently are permitted to decay and are eventually removed from the encrypted preference datastore (104). For example, if Sarah searches for “vegetarian recipes” repeatedly over several weeks, this recurrence pattern promotes the triple (Sarah, interested_in, “vegetarian recipes”) to a durable status, whereas a single search for “ice sculpture techniques” may decay after a few epochs if not repeated.

The on-device extraction (708) produces a set of candidate triples (710) from the four input categories described above. The candidate triples (710) are proposed for user confirmation (712) before being written to the encrypted preference datastore (104). In one embodiment, the candidate triples (710) are presented to the user with provenance metadata indicating the source interaction from which each triple was derived, and an instant-deletion affordance that enables the user to remove any candidate triple immediately and permanently. For example, Sarah's device may display a notification stating “Based on your recent searches, I've noted that you're interested in dog-friendly hiking trails. Would you like to keep this preference?” with options to confirm, dismiss, or view the source interaction. In another embodiment, the candidate triples (710) are auto-added to the encrypted preference datastore (104) with provenance metadata, and the user may review and delete them at any time through a preference management interface.

The enrichment process applies a promote-or-decay mechanism (714) to manage the lifecycle of triples in the encrypted preference datastore (104). Recurring signals are promoted to durable triples that persist across epochs, while non-recurring signals are permitted to decay. The decay mechanism ensures that the encrypted preference datastore (104) does not accumulate stale or irrelevant preferences over time. The user device (100) honors a user-accessible control (716) that disables agentic-action enrichment entirely. When the disable control (716) is activated, the composition engine (108) does not extract candidate triples from any agentic interaction, and the encrypted preference datastore (104) is enriched only through explicit user input. This provides the user with complete control over whether the system learns from their agentic interactions.

An important property of the preference enrichment process is that the enrichment occurs after the response from the external service (120) is received and the composed output (410) is presented to the user. This timing ensures that the scrubbed request (300) sent through the split-trust transport carries no term of the encrypted preference datastore (104), including any terms that might be derived from newly enriched preferences. No enrichment datum is transmitted from the user device (100) at any point during or after the enrichment process. The entire enrichment pipeline, from extraction through confirmation to storage, operates exclusively on the user device (100).

Referring now to FIG. 8, the preference-graph contribution process is described. The user device (100) optionally contributes an anonymized abstraction of the encrypted preference datastore (104) and a record of agentic-action history to an aggregated knowledge graph (136). This contribution enables the system to derive collective behavioral intelligence, including trending action types, emerging patterns, demand signals, query and intent co-occurrence, cold-start personalization defaults for new users, and a privacy-preserving behavioral-trends data product, all without the server learning any individual action, query, preference, or identity. The contribution process is designed such that no aggregator observes any individual contribution value, and the resulting aggregate signals are restricted to verified, deduplicated humans, making them structurally resistant to bot and Sybil inflation.

In the first step, the user device (100) projects the relevant portions of the encrypted preference datastore (104) and the agentic-action history into a coarsened tuple (800). The coarsened tuple (800) comprises at least an action category (for example, “search” or “document-composition”), a topic bucket (for example, “outdoor recreation” or “Italian cuisine”), a coarse region (for example, “Western United States” or “Northern Europe”), and an epoch (for example, “2026-W22” representing a particular calendar week). The coarsening operation is performed entirely on the user device (100), and raw queries, fine-grained triples, specific action details, and any personally identifying information are never transmitted. The purpose of coarsening is to reduce the granularity of the contributed data to a level at which individual user behavior cannot be reconstructed, while preserving enough signal to enable meaningful aggregate analysis. For example, if Sarah performed three searches for “hiking trails near Denver” during a given week, the coarsened tuple contributed by her device might be (action_category: “search”, topic_bucket: “outdoor recreation”, coarse_region: “Western US”, epoch: “2026-W22”), with no indication of the specific query, the number of searches, or the user identity.

In the second step, the contribution is secret-shared (802) across two or more non-colluding aggregators, specifically the first aggregator (132) and the second aggregator (134), such that no aggregator observes an individual contribution value. In one preferred embodiment, the contribution value is split into shares using a verifiable private-aggregation scheme, and each share is transmitted to a different aggregator. The first aggregator (132) and the second aggregator (134) are operated by independent entities that do not collude. Each aggregator receives only its share of the contribution and cannot reconstruct the individual contribution value from its share alone. The aggregators can jointly compute only aggregate statistics, such as a sum or count, over the contributions received from all users. For example, if one thousand users each contribute a secret-shared coarsened tuple for the topic bucket “outdoor recreation” in a given week, each aggregator receives one thousand shares, but neither aggregator can determine any individual user's contribution. The aggregators can jointly compute that one thousand verified humans contributed to the “outdoor recreation” topic bucket in that week, but neither can identify which users contributed.

In the third step, the user device (100) generates a tokenized contribution identifier (804) bound to the user's verified-human identity and to the coarsened tuple (800). The tokenized contribution identifier (804) ensures that at most one contribution per human per epoch per coarsened tuple is admitted, thereby preventing any single user from inflating the aggregate signals by contributing multiple times for the same coarsened tuple within the same epoch. In one preferred embodiment, the tokenized contribution identifier (804) is computed analogously to the action nullifier described with reference to FIG. 5, by way of non-limiting example as akg_nullifier=Poseidon(nullifierKey∥“akg”∥epoch∥bucket). The tokenized contribution identifier (804) is accompanied by a zero-knowledge proof of membership in the verified-human registry (124), ensuring that only registered verified humans can contribute. Because contributions are restricted to verified, deduplicated humans and limited to one per human per epoch per coarsened tuple, the resulting aggregate signals are structurally resistant to bot and Sybil inflation. An automated bot network, for example, cannot create fake contributions because each contribution requires a zero-knowledge proof derived from a biometric-anchored Secret-Key (S1) (502) bound to a secure enclave.

In the fourth step, the aggregated knowledge graph (136) discloses a coarsened tuple (800) only upon satisfaction of a threshold (806) of distinct verified-human contributors. In one preferred embodiment, the threshold disclosure (806) is a k-anonymity threshold, meaning that a coarsened tuple is disclosed in the aggregated knowledge graph (136) only when at least k distinct verified humans have contributed that coarsened tuple within the epoch, where k is a predetermined integer. Sub-threshold contributions remain cryptographically unopenable. For example, if the k-anonymity threshold is set to fifty, then a coarsened tuple for the topic bucket “rare tropical fish care” contributed by only twelve verified humans in a given week would not be disclosed in the aggregated knowledge graph (136), because the twelve contributions fall below the threshold of fifty. This prevents the disclosure of data that might, due to its rarity, enable the identification or re-identification of individual contributors. Only when at least fifty distinct verified humans contribute to the same coarsened tuple does the aggregate count become available. For disclosed coarsened tuples, the system computes an aggregate count corresponding to the coarsened tuple and the epoch, representing the total number of distinct verified-human contributors.

In one embodiment, the user device (100) adds calibrated noise (808) to the contribution prior to secret-sharing to provide a differential-privacy guarantee. The calibrated noise is drawn from a statistical distribution, such as a Laplace or Gaussian distribution, with parameters chosen to provide a specified level of differential privacy (for example, epsilon-differential privacy). The noise is added on the user device (100) before the contribution is split into shares and transmitted to the aggregators, ensuring that even if the aggregators were to collude (in violation of the system's trust assumptions), the individual contribution would be obscured by the added noise. The combination of secret-sharing across non-colluding aggregators, k-anonymity threshold disclosure, and on-device calibrated noise provides multiple layers of privacy protection for the contribution process.

The resulting aggregated knowledge graph (136) produces a set of aggregate outputs (810) that serve multiple purposes within the system and for external consumers. These outputs include trending and freshness signals across action categories, enabling the system to identify which types of agentic actions are increasing or decreasing in popularity. The outputs further include query-understanding signals such as autocomplete suggestions, spelling corrections, intent disambiguation, and co-occurrence patterns, all derived from aggregate data without any individual-level information. The outputs include cold-start personalization defaults for new users, enabling the system to provide reasonable initial preferences for users who have not yet built up a personal preference history in the encrypted preference datastore (104). The outputs include demand signals for product, advertising, and marketplace surfaces, enabling business applications to understand aggregate trends without learning about individual users. All such signals are derived without the server learning any individual action, query, preference, or identity.

The preference-graph contribution process described with reference to FIG. 8, in combination with the anonymous metering process described with reference to FIG. 5, ensures that the platform backend retains no action history and no mapping between any agentic action and any human. The backend retains spent action nullifiers (which are unlinkable to user identities), above-threshold aggregate counts keyed by coarsened tuple, secret-share material that is insufficient alone to reconstruct any individual contribution, and entitlement-verification keys. The backend never retains request text, action history, user preferences, or any identity-to-usage mapping. Consequently, compromise of any single component of the system yields either content without identity, or identity without content, but never both, and never a complete action history for any user.

1. A method for enabling a user to interact with one or more external artificial-intelligence services such that the services receive an authenticated request without receiving the user identity or personal data, the method comprising:
at a user device (100) having a secure enclave, receiving a set of biometric samples of the user;
computing a Secret-Key (S1) (502) from the set of biometric samples on the user device (100) and binding the Secret-Key (S1) to the secure enclave such that the Secret-Key (S1) is non-exportable from the secure enclave;
deriving, by application of a Function (F1) (504) to the Secret-Key (S1), a tokenized identity proof (506) bound to a context comprising at least an action category and an epoch, the tokenized identity proof (506) being verifiable as originating from a registered verified human in a verified-human registry (124) without revealing the user identity;
receiving, at the user device (100), an agentic request from the user;
classifying the agentic request, on the user device (100), by intent type via an intent and capability classification (202) and selecting a tier from among a local-execution tier (204), a local-resource-match tier (106), and an external-service tier (206);
responsive to selection of the external-service tier (206), forming a scrubbed request (300) from the agentic request by removing personal entities and terms derived from an encrypted preference datastore (104) stored on the user device (100);
transmitting the scrubbed request and the tokenized identity proof (506) through a split-trust transport that conveys the scrubbed request to an external service (120) without conveying the user identity or a network address of the user device (100);
receiving a response from the external service (120) via the split-trust transport;
composing, on the user device (100), an output (410) by ranking and synthesizing the response against the encrypted preference datastore (104) without transmitting the encrypted preference datastore (104); and
metering, at an action-nullifier set server (126), the agentic action by verifying and consuming the tokenized identity proof (506), the action-nullifier set server (126) recording an aggregate count corresponding to the action category and the epoch, the action-nullifier set server (126) being devoid of a mapping between the aggregate count and the user identity.

2. The method of claim 1, wherein the split-trust transport comprises:
a first party (116) that observes a network address but not the scrubbed request; and
a second party (118), the second party (118) being operated by an entity independent of the first party (116), that observes the scrubbed request but not the network address or the user identity, such that no single party observes both the user identity and the scrubbed request.

3. The method of claim 2, wherein the split-trust transport encapsulates the scrubbed request under a public key associated with the second party (118) using a hybrid public-key encryption scheme (302) such that: the first party (116) observes only an opaque encapsulated request; and only the second party (118) can decrypt the scrubbed request.

4. The method of claim 1, wherein the tokenized identity proof (506) comprises a cryptographic hash of:
(i) a key derived from the Secret-Key (S1) (502) by application of a key-derivation function (504);
(ii) a context string comprising the action category;
(iii) the epoch; and
(iv) a slot within a range [0, N) where N is dependent on the action category and an entitlement tier, accompanied by a zero-knowledge proof (508) of membership in the verified-human registry (124) without revealing the user identity.

5. The method of claim 4, wherein:
the cryptographic hash comprises a zero-knowledge-friendly hash function;
the zero-knowledge proof (508) comprises a non-interactive zero-knowledge argument of knowledge; and
the tokenized identity proof (506) is transmitted to the action-nullifier set server (126) via a sealed-sender transport (510) that conceals a sender network identity.

6. The method of claim 1, wherein the agentic request is selected from the group consisting of:
a search query;
a request to draft, revise, or summarize a document;
a request to coordinate one or more calendar events;
a request to execute a financial transaction;
a request to plan and execute a multi-step task (406); and
a request involving interaction with another party's personal agent (408).

7. The method of claim 1, wherein:
the external service (120) comprises one of an artificial-intelligence model, a search index, a programmable interface, and a computer-implemented service; and
the response is received via the split-trust transport in encapsulated form.

8. The method of claim 1, wherein classifying the agentic request in step (e) further comprises:
applying a freshness gate whereby time-sensitive markers in the agentic request or stale local knowledge in the encrypted preference datastore (104) route the agentic request to the external-service tier (206); and
applying a capability gate whereby agentic requests resolvable by local resources of the user device (100), including the encrypted preference datastore (104) and a local capability matcher (106), are routed to the local-resource-match tier, the intent and capability classification (202) thereby minimizing data egress from the user device (100).

9. The method of claim 1, further comprising contributing an anonymized abstraction of the encrypted preference datastore (104) and a record of agentic-action history to an aggregated knowledge graph (136), by:
(i) coarsening the abstraction to a coarsened tuple (800) comprising at least an action category, a topic bucket, a coarse region, and an epoch;
(ii) generating a tokenized contribution identifier (804) bound to the user's verified-human identity and to the coarsened tuple (800), such that at most one contribution per human per epoch per coarsened tuple is admitted;
(iii) disclosing the coarsened tuple in the aggregated knowledge graph (136) only upon satisfaction of a threshold (806) of distinct verified-human contributors; and
(iv) computing, for disclosed coarsened tuples, an aggregate count corresponding to the coarsened tuple and the epoch.

10. The method of claim 9, wherein:
the contribution is secret-shared (802) across two or more non-colluding aggregators (132, 134) such that no aggregator observes an individual contribution value; and
the threshold disclosure (806) is a k-anonymity threshold.

11. The method of claim 9, further comprising: on the user device (100), adding calibrated noise (808) to the contribution prior to secret-sharing to provide a differential-privacy guarantee.

12. The method of claim 1, further comprising:
issuing one or more entitlement tokens (604) to the user device (100) by a blind-signature protocol (602) such that an issuer signs each entitlement token without observing its content;
presenting an entitlement token to an entitlement verifier (130) to invoke a premium capability (612); and
verifying a signature of the entitlement token at the entitlement verifier (130) without linking the entitlement token to its issuance, whereby billing for the premium capability is cryptographically unlinkable to agentic usage thereof.

13. The method of claim 1, further comprising enriching the encrypted preference datastore (104) on the user device (100) by:
extracting (708) candidate triples from at least one of: content of the agentic request (700) yielding interested_in triples, local engagement signals and user reactions (702) yielding engagement_history triples, refinements or dismissals (704) yielding avoids triples, and recurrence patterns across epochs (706);
proposing (710) the candidate triples for user confirmation with provenance metadata and an instant-deletion affordance (712);
promoting (714) recurring signals to durable triples while permitting non-recurring signals to decay; and
honoring a user-accessible control (716) that disables agentic-action enrichment, wherein no enrichment datum is transmitted from the user device (100) and the enrichment occurs after the response is received such that the scrubbed request (300) carries no term of the encrypted preference datastore (104).

14. The method of claim 1, further comprising:
a maximum-privacy mode that disables on-device ranking and synthesis against the encrypted preference datastore (104) and transmits only a minimal scrubbed request through the split-trust transport.

15. A system for enabling a user to interact with one or more external artificial-intelligence services such that the services receive an authenticated request without receiving the user identity or personal data, comprising:
a user device (100) having a secure enclave, the user device (100) configured to compute a Secret-Key (S1) (502) from a user biometric, to bind the Secret-Key (S1) to the secure enclave such that the Secret-Key (S1) is non-exportable from the secure enclave, and to derive, by application of a Function (F1) (504) to the Secret-Key (S1), a tokenized identity proof (506) bound to a context comprising at least an action category and an epoch, the user device (100) further configured to classify an agentic request by intent type, to form a scrubbed request (300) from the agentic request by removing personal entities and terms derived from an encrypted preference datastore (104), and to compose an output (410) by ranking and synthesizing a response from an external service (120) against the encrypted preference datastore (104);
an action gateway (118) configured to receive scrubbed requests (300) accompanied by tokenized identity proofs (506) and to dispatch the scrubbed requests to one or more external services (120);
an oblivious relay (116), the oblivious relay (116) being operated by an entity independent of the action gateway (118), configured to forward encapsulated requests (302) from the user device (100) to the action gateway (118) such that the oblivious relay (116) observes a network address but not the scrubbed request and the action gateway (118) observes the scrubbed request but not the network address or the user identity;
a verified-human registry (124) maintaining identity commitments of verified humans;
an action-nullifier set server (126) configured to verify and consume tokenized identity proofs (506) and to record an aggregate count corresponding to the action category and the epoch, the action-nullifier set server (126) being devoid of a mapping between the aggregate count and the user identity; and
an entitlement verifier (130) configured to verify a signature of an unlinkable entitlement token (604) issued by a blind-signature protocol (602) without linking the entitlement token to its issuance.

16. The system of claim 15, wherein: the action gateway (118) comprises a cache keyed by a normalized request string and shared across users.

17. The system of claim 15, further comprising:
a first aggregator (132) and a second aggregator (134) operated by independent entities, configured to receive secret-shared contributions (802) corresponding to anonymized abstractions of encrypted preference datastores (104) of respective user devices; and
to disclose coarsened tuples (800) in an aggregated knowledge graph (136) only upon satisfaction of a k-anonymity threshold (806) of distinct verified-human contributors.

18. An apparatus comprising:
a processor;
one or more biometric sensors;
a secure enclave to which a Secret-Key (S1) (502) derived from a user biometric captured by the one or more biometric sensors is bound as non-exportable from the secure enclave; and
a memory storing instructions that, when executed by the processor, cause the apparatus to:
derive from the Secret-Key (S1) (502), by application of a Function (F1) (504), a tokenized identity proof (506) bound to a context comprising at least an action category and an epoch, the tokenized identity proof (506) being verifiable as originating from a registered verified human in a verified-human registry (124) without revealing the user identity;
receive an agentic request from a user;
classify the agentic request by intent type via an intent and capability classification (202) and select a tier from among a local-execution tier (204), a local-resource-match tier (106), and an external-service tier (206);
form a scrubbed request (300) from the agentic request, excluding personal entities and terms derived from an encrypted preference datastore (104) stored on the apparatus;
transmit the scrubbed request and the tokenized identity proof (506) through a split-trust transport that conveys the scrubbed request to an external service (120) without conveying the user identity or the apparatus's network address;
receive a response from the external service (120) via the split-trust transport;
compose, on the apparatus, an output (410) by ranking and synthesizing the response against the encrypted preference datastore (104) without transmitting the encrypted preference datastore (104); and
meter the agentic action by transmitting the tokenized identity proof (506) to an action-nullifier set server (126) for verification and consumption, the action-nullifier set server (126) recording an aggregate count corresponding to the action category and the epoch, the action-nullifier set server (126) being devoid of a mapping between the aggregate count and the user identity.

19. The apparatus of claim 18, wherein the secure enclave comprises:
a hardware-isolated execution environment selected from the group consisting of: an Apple Secure Enclave Processor, an Android StrongBox Keymaster, an ARM TrustZone, an Intel SGX environment, an AMD SEV environment, and a hardware security module, configured to store one or more cryptographic keys as non-exportable from the secure enclave.

20. A non-transitory computer-readable medium storing instructions that, when executed by a processor coupled to a memory and a secure enclave of a user device (100), cause the processor to perform operations comprising:
computing a Secret-Key (S1) (502) from a user biometric on the user device (100) and binding the Secret-Key (S1) to the secure enclave of the user device (100) such that the Secret-Key (S1) is non-exportable from the secure enclave;
deriving, by application of a Function (F1) (504) to the Secret-Key (S1), a tokenized identity proof (506) bound to a context comprising at least an action category and an epoch, verifiable as originating from a registered verified human in a verified-human registry (124) without revealing the user identity;
receiving an agentic request from a user;
classifying the agentic request by intent type and routing the agentic request, on the user device (100), to a least-revealing sufficient tier from among a local-execution tier (204), a local-resource-match tier (106), and an external-service tier (206);
forming a scrubbed request (300) from the agentic request, excluding personal entities and terms derived from an encrypted preference datastore (104) stored on the user device (100);
transmitting the scrubbed request and the tokenized identity proof (506) through a split-trust transport that conveys the scrubbed request to an external service (120) without conveying the user identity or a network address;
composing an output (410) on the user device (100) by ranking and synthesizing a response from the external service (120) against the encrypted preference datastore (104) that is not transmitted;
metering the agentic action by transmitting the tokenized identity proof (506) to an action-nullifier set server (126) for verification against the verified-human registry (124), the action-nullifier set server (126) recording an aggregate count and being devoid of a mapping between the aggregate count and the user identity; and
contributing a threshold-gated, secret-shared (802) abstraction of the encrypted preference datastore (104) and a record of agentic-action history to an aggregated knowledge graph (136).

21. The medium of claim 20, wherein the agentic request is one of:
a search query producing a synthesized cited answer (402);
a document-composition request producing a final document integrated with on-device personal context (404);
a calendar-coordination request producing a scheduled event without revealing the user's calendar to an external party;
a financial-transaction request executed with verified-human authorization;
a multi-step planning request (406) executed by chaining a plurality of transmissions through the split-trust transport; and
an agent-to-agent interaction (408) in which a counterparty agent does not learn the user identity or the encrypted preference datastore (104).

22. The medium of claim 20, wherein:
the Function (F1) (504) and the tokenized identity proof (506) are implemented by a key-derivation function and a zero-knowledge-friendly hash, respectively;
the split-trust transport encapsulates the scrubbed request under a public key (302) such that no single party observes both the user identity and the scrubbed request;
the contribution to the aggregated knowledge graph (136) is secret-shared (802) across non-colluding aggregators (132, 134) subject to a k-anonymity threshold (806); and
an unlinkable premium entitlement (612) is gated by entitlement tokens (604) issued under a blind-signature protocol (602).
